(19) United States
(12) Patent Application Publication
(10) Pub. No.: US 2019/0091720 A1
(43) Pub. Date: Mar. 28, 2019

(54) BATTERY POWERED DISPENSER FOR ONE AND TWO COMPONENT FOILS AND CARTRIDGES

(71) Applicants: HENKEL AG & CO. KGaA, Duesseldorf (DE); Meritool LLC, Salamanca, NY (US)

(72) Inventors: Timm Randal Herman, Ellicottville, NY (US); Brent Michael Findlay, East Concord, NY (US); Joachim Plotzitzka, Kleinsteinbach Gem. Pfinztal (DE); Matthias Heim, Ketsch (DE)

(21) Appl. No.: 16/085,790

(22) PCT Filed: Mar. 16, 2017
(86) PCT No.: PCT/US17/22634

§ 371 Date: Sep. 17, 2018

Related U.S. Application Data
(60) Provisional application No. 62/309,161, filed on Mar. 16, 2016.

(51) Int. Cl. B05C 17/005; B05C 17/01

(52) U.S. Cl. CPC B05C 17/00596; B05C 17/00553; B05C 17/0103; B05C 17/00583

(57) ABSTRACT

An assembly for a dispenser includes a front plate having a first tube aperture configured for securably receiving a tube within the aperture, the tube being configured to receive a container having a flowable material; a release assembly disposed on the front plate having first and second members hingingly movable about a hinge portion on each of the first and second members for partially covering the first tube aperture when the first and second members are in a closed position and for uncovering the aperture when the first and second members are in an open position. A combination includes a dispenser and the assembly releasably secured to the discharge gun. A kit includes a container having a flowable material; the dispenser having plunger; and the assembly releasably secured to the discharge gun.

### FIELD OF THE INVENTION

The present disclosure is related to an assembly of a dispenser for delivery of a flowable material. In particular, the present disclosure is related to an assembly for releasably securing cartridges or foils containing flowable materials for use with the dispenser or dispensing gun.

### BACKGROUND OF THE INVENTION

Flowable material such as adhesive or sealant is typically applied from a container. Known containers include cartridges and sausages or foils. Cartridges comprise a cylindrical hard shell containing the flowable material, an outlet at one end and a piston at the opposing end. The cartridge is placed in a dispenser or dispensing gun. Actuation of the dispenser moves a driving rod linearly to move the cartridge piston toward the cartridge outlet, expelling the flowable material from the outlet. In larger applications the flowable material is contained in a “sausage” or “foil”. Sausages and foils comprise a generally cylindrical container made of a flexible, film type material. The flexible material surrounds and is sealed around the flowable material and has an outlet at one end. The sausage or foil is placed in a dispenser or dispensing gun. Actuation of the dispenser moves a plunger at the end of the driving rod linearly to collapse the sausage or foil, expelling the flowable material from the outlet.

Current dispensing guns are not ergonomically arranged and installing and removing cartridges or sausages containing flowable material into and from dispensing guns, especially ones having multiple cartridges, is a cumbersome and time consuming operation. Some dispensing guns use a slot through which the nozzle of the cartridge is loaded. The slot allows the front of the cartridge to climb when the dispensing gun is actuated, allowing the dispensing gun plunger to move off center. There is a need in the art for an improved assembly permitting easily and convenient installation and removal of cartridges for use with a dispenser or dispensing gun.

### SUMMARY OF THE INVENTION

The present disclosure provides an assembly for use with a dispenser or dispensing gun. The assembly includes rotatably moveable front members; moveable between an open position and a closed position about a front plate. In the open position, tubes in the assembly are accessible for loading or removing cartridges containing flowable materials. In the closed position, the cartridges are secured in the assembly. The assembly includes a rear plate which may be secured to a dispenser or dispensing gun. The front plate and the rear plate are secured to each other, thereby securing the tubes in the assembly.

In another aspect of the present disclosure, a combination of the assembly and dispenser or dispensing gun is provided.

In another aspect of the present disclosure, a kit containing the assembly, the dispenser or dispensing gun and cartridges or foils containing flowable materials is provided.

These and other features and advantages of the present disclosure will become apparent from the following detailed description of illustrative embodiments thereof, which is to be read in connection with the accompanying drawings. Corresponding reference element numbers or characters indicate corresponding parts throughout the several views of the drawings.

### BRIEF DESCRIPTION OF THE DRAWINGS

FIG. 1 is a perspective of a combination of a dispensing gun and an assembly for containing cartridges having flowable materials according to the present disclosure.

FIG. 2 is a cross sectional view of a hard shell cartridge having a flowable fluid useful with the combination of FIG. 1.

FIG. 3 is a cross sectional view of a sausage or foil having a flowable fluid useful with the combination of FIG. 1.

FIG. 4 is a front view of a front portion of the assembly of FIG. 1 having a front plate with movable members for providing ingress and egress of cartridges or sausages containing flowable fluids.

FIG. 5 is a side, partial perspective view of a rear portion of front plate of FIG. 4.

FIG. 6 is a view of a spring loaded lock pin useful with the assembly for the combination of FIG. 1.

FIG. 7 is a view of a hinge pin useful with the assembly for the combination of FIG. 1.

FIG. 8 is a view of a bolt useful with the assembly for the combination of FIG. 1.

FIG. 9 is a view of a coil spring useful with the assembly for the combination of FIG. 1.

FIG. 10 is a perspective view of a manifold for combining flows from two cartridges or sausages and useful with the assembly for the combination of FIG. 1.

FIG. 11 is a perspective view of one embodiment of the front plate and movable members.

FIG. 12 is a perspective view of one embodiment of the moveable members.

FIG. 13 is a rear perspective view of the assembly for the combination of FIG. 1.

FIG. 14 is a partial perspective view of one embodiment of a front plate.

FIG. 15 is another partial perspective view of one embodiment of a rear plate.

FIG. 16 is an elevational side view of another embodiment of a dispensing gun and an assembly for containing cartridges.

FIG. 17 is a side perspective view of the embodiment of FIG. 16.

FIG. 18 is a side perspective view of the embodiment of FIG. 16 showing the movable members in an open position.

FIG. 19 is a side perspective view of the embodiment of FIG. 16 from a different angle.

FIG. 20 is an elevational view of the opposing side of the dispensing gun and assembly of FIG. 16.

FIG. 21 is a perspective view of the embodiment of FIG. 20.

FIG. 22 is a side perspective view of the embodiment of FIG. 21 from a different angle.

FIG. 23 is a front elevational view of the embodiment of FIG. 16.

FIG. 24 is a front elevational view of the embodiment of FIG. 16 showing the movable members in an open position.

FIG. 25 is a rear elevational view of the embodiment of FIG. 16.

FIG. 26 is a top plan view of the embodiment of FIG. 16.

FIG. 27 is a bottom plan view of the embodiment of FIG. 16.

FIG. 28 is another embodiment of a front plate and movable members.

FIG. 29 is a partial cross section of a portion of FIG. 28.

FIG. 30a is another embodiment of a release assembly in the locked position.

FIG. 30b is the release assembly of FIG. 30a in the released position.

FIG. 31 is a partial, partly sectional, view of one embodiment of a movable member.

FIG. 32 is a perspective view of one embodiment of a rear plate.

### DETAILED DESCRIPTION

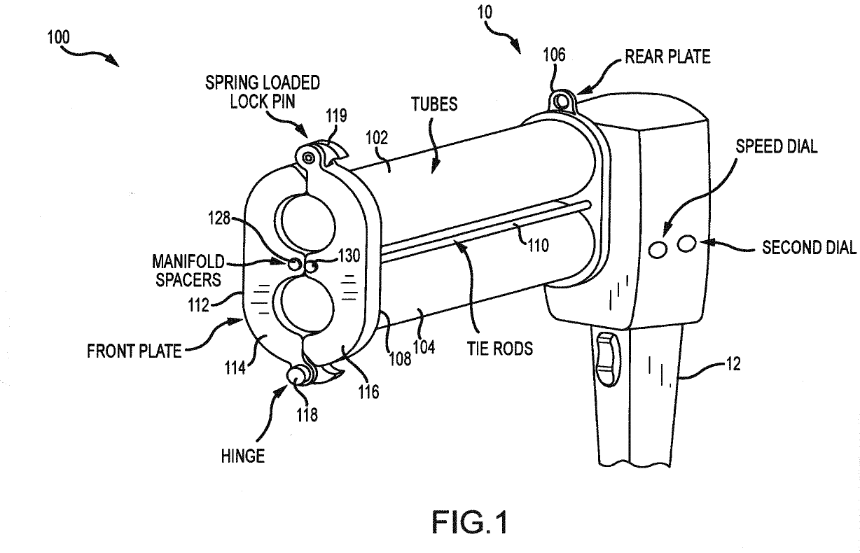

FIG. 1 is a perspective view of a combination 10 having a dispensing gun or dispenser 12 and an assembly 100. The assembly 100 is useful for holding containers of flowable materials such as cartridges 14 or sausages or foils 26 for dispensing. The dispenser 12 may have a power source (not shown), such as a battery for supplying power to dispense flowable materials. In other embodiments the dispenser may be powered by other power sources, such as pneumatic or a corded electrical source. In other embodiments a manual power source, such as a hand crank or hand pistol arrangement, may also be used. Dispensers 12 useful with the assembly 100 are commercially available. Battery powered dispensers are commercially available, for example from Meritool LLC of Salamanca N.Y.

The assembly 100 includes tubes 102, 104 securably disposed between a front plate 108 and a rear plate 106. Preferably, the tubes 102, 104 are arranged in a vertical orientation to improve ergonomics of the assembly 100. Tie rods 110 are attached to the front plate 108 and rear plate 106 to secure the tubes 102, 104 between the front plate 108 and the rear plate 106. The rear plate 106 may be securably attached to the dispenser 12 such as by screws (not shown). The present disclosure, however, is not limited and other methods, including releasable methods, may be used to attach the rear plate 106 to the dispenser 12. Although two tubes 102, 104 are depicted in FIG. 1, any suitable number of tubes may be used, including a single tube or multiple tubes in excess of two.

The tubes 102, 104 are open cylindrical tubes configured to receive flowable material containing cartridges or sausages or foils. The tubes of FIG. 1 have a diameter of about 50 mm, however larger or smaller tubes can be used to suit the intended purpose. While the tubes 102, 104 are depicted as being substantially circular in cross-section, the present disclosure is not so limited and other shapes may suitably be used. Further, the tubes, individually or in combination, may be multi-lumen tube or tubes.

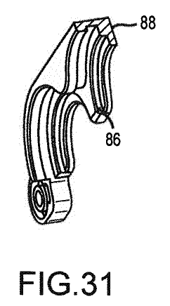

The front plate 108 includes a release assembly 112 having first and second moveable members 114 and 116. The moveable members 114, 116 are rotatably moveable about a hinge portion or mechanism 118 and are releasably secured to each other by a lock mechanism 119. The moveable members 114, 116 are in their closed position in FIG. 1. In the closed position the moveable members 114, 116 partially cover the open ends of the tubes 102, 104 to secure containers (not shown) having flowable material therein. In the closed position, the moveable members 114, 116 may form openings to approximate the geometry of the open ends of the tubes 102, 104, but the openings are smaller in their effective closed diameter than the corresponding diameters of the tubes 102, 104 and the corresponding diameters of containers (not shown) disposed within the tubes 102, 104. In one embodiment shown best in FIG. 31, the movable member 114, 116 openings have a chamfered bore 86 that is larger in diameter in the direction of the gun and tapers to a smaller diameter as the bore extends toward the forward face 88. The chamfered bore helps guide containers 14, 26 into axial alignment with the tube 102, 104 bore as the movable members 114, 116 are moved to the closed position. In some variations the moveable members 114, 116 can be identical and used interchangeably.

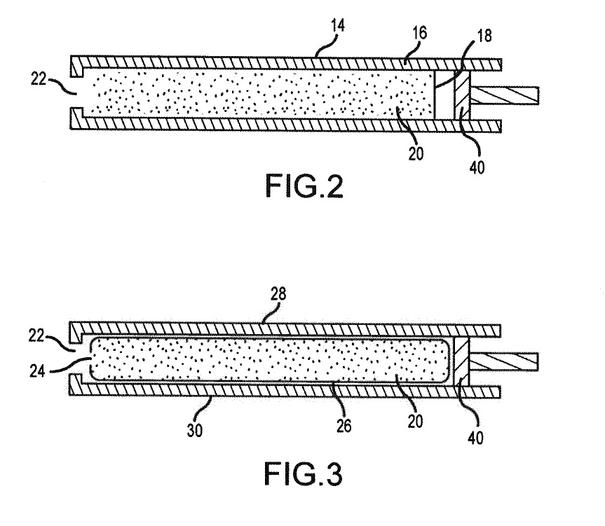

FIG. 2 is a cross-sectional view of a cartridge 14 having a flowable material 20 useful with the assembly 100. The cartridge 14 may include a hard shell 16. The cartridge 14 may have an opening 22 for the egress of the flowable material 20. The opening 22 may comprise a releasable seal (not shown) and/or an outlet (not shown) for fluidly attaching mixing manifolds, mixing nozzles or dispensing nozzles to the cartridge 14. The cartridge 14 comprises an internal piston or plunger 18 that is longitudinally movable between a position adjacent the rear plate to a position toward the front plate by actuation of the dispenser. Movement of the piston or plunger 18 toward the front plate may be used to force the flowable material 20 out of the cartridge 14. Other techniques for forcing the flowable material 20 out of the cartridge 14 may be suitably used.

FIG. 3 is a cross-sectional view of a sausage or foil 26 having a flowable material 20 therein useful with the assembly 100. The sausage or foil 26 comprises a thin and flexible film-like material forming a flexible foil or bag 30 within which the flowable material 20 may be disposed. The foil or bag 30 may be disposed within a tube 102, 104. The foil or bag 30 may have an opening 24. Opening 24 may comprise a releasable seal (not shown) and/or an outlet (not shown) for fluidly attaching mixing manifolds, mixing nozzles or dispensing nozzles to the cartridge 14. The dispenser 12 comprises a piston or plunger 40 that is longitudinally movable between a position adjacent the rear plate to a position toward the front plate by actuation of the dispenser. Movement of the piston or plunger 40 toward the front plate may be used to force the flowable material 20 out of the sausage or foil 26. The flexible foil or bag 30 collapses as the flowable material is dispensed. Other techniques for forcing the flowable material 20 out of the container 14 may be suitably used.

The flowable material 20 may be a viscous or pasty flowable material. Useful materials may include, but are not limited to, caulks, sealants, adhesives and the like. The flowable materials 20 used in the combination 10 may be the same or different in the containers 14, 30. The flowable materials 20 may include multi-component systems that chemically react when mixed such as but not limited to two part epoxies and two part polyurethanes. For such multi-component materials, one component may be disposed within one of the containers 14, 30; and a different component may be disposed within the other of the containers 14, 30. In another embodiment tubes 102, 104 are replaced with a single dual-shaped container (not shown) having two open lumens in a figure-8 configuration where different components are disposed within the different lumens. In such a case the containers may have a geometry (not shown) matching the figure-8 configuration such as two parallel sausages joined by a web of material. In another embodiment the flowable material 20 can be a one-component material such as, for example, a one-component polyurethane composition that cross-links and cures when exposed to moisture. In this embodiment one or both of tubes 102, 104 contain a cartridge or foil containing the same material.

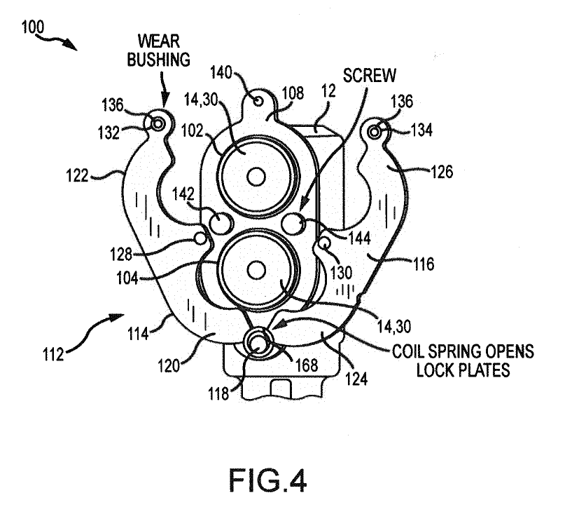

FIG. 4 is front view of the release assembly 112 of FIG. 1. The first moveable member 114 has an upper portion 122 and a lower portion 120, and the second moveable member 116 has an upper portion 126 and a lower portion 124. The lower portions 120, 124 of the respective first and second moveable members 114, 116 are rotatably engaged with the hinge portion or hinge mechanism 118. This allows the upper portions 122, 126 of respective first and second moveable members 114, 116 to move between the closed position depicted in FIG. 1 to an open position depicted in FIG. 4. In the open position of the first and second moveable member 114, 116, the tubes 102, 104, which may have containers 14, 30, are exposed. The containers 14, 30 may be removed from the tubes 102, 104, and new containers 14, 30 may then be disposed within the tubes 102, 104. The first and second members 114, 116 may then be moved to their closed position as depicted in FIG. 1.

As depicted in FIG. 4, the first and second members 114, 116 are moveable about the front plate 108. The first and second members 114, 116 may contain manifold spacers 128, 130, respectively.

The upper portions 122, 126 of the respective first and second moveable members 114, 116 may have holes or apertures 132, 134. The holes or apertures 132, 134 may have a wear bushing 136, 138 securable disposed therein. The wear bushings 136, 138 are useful with the lock mechanism 119 which is described below in further detail. Bolts 142, 144 are useful for securing the tie rods 110 to the front plate 108.

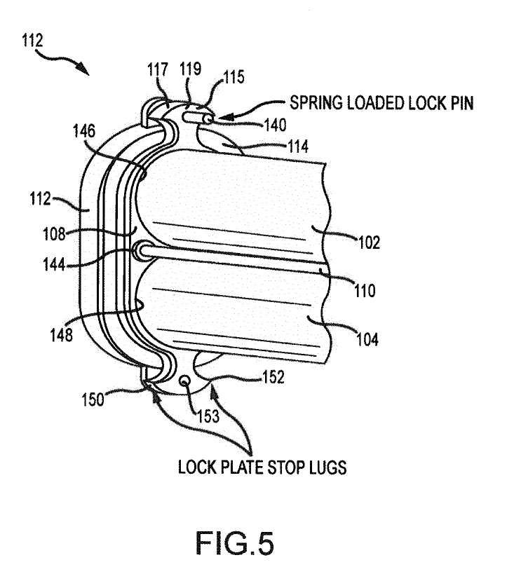

FIG. 5 is a partial perspective and rear view of the release assembly 112. Lock plate stop lugs 150, 152 may be disposed at a bottom portion 153 of the front plate 108. The lock plate stop lugs 150, 152 may be used to limit the degree of rotation of the lower portion 120, 124 of the respective first and second members 114, 116 about the hinge mechanism 118.

The front plate has open orifices 146, 148. The tubes 102, 104 may be securably disposed within the respective orifices 146, 148. For example, the tubes 102, 104 may be securably threaded into the orifices 146, 148. The present disclosure, however, is not so limited, and other techniques for securing the tubes 102, 104 to the front plate 108 may suitably be used. For example, the tubes 102, 104 may be pressed fitted into the orifices 146, 148; the tubes 102, 104 may be welded into the orifices 146, 148; the tubes 102, 104 be adhesively bonded into the orifices 146, 148; or the front plate 108 and tubes 102, 104 may be formed as a unitary structure.

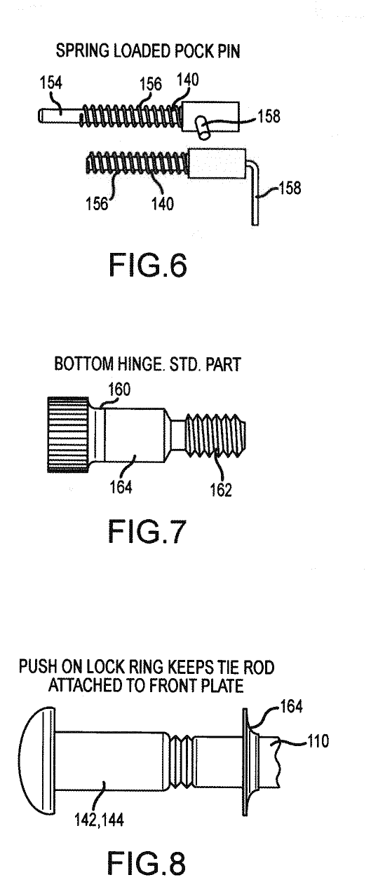

The upper portion 117 of the front plate 108 contains the lock mechanism 119. The lock mechanism 119 may be in the form of a spring loaded lock pin 140. One useful spring loaded lock pin 140 is depicted in FIG. 6. The spring loaded lock pin 140 may include a slidable portion 154, a threaded portion 156 and an access portion 158. The threaded portion 156 can be threaded into the front plate 108. The spring loaded lock pin 140 is biased so that the slidable portion 154 is normally extended from the threaded portion 156 as shown in FIG. 6, upper illustration. In this configuration when the threaded portion is engaged in the front plate 108 the slidable portion 154 is disposed within wear bushings 136, 138 of the respective first and second members 114, 116 when the first and second members 114, 116 are in the closed position as depicted in FIG. 1. This represents a locked position of the spring loaded lock pin 140.

The access portion 158 may be pulled or otherwise manipulated to withdraw the slidable portion 154 against the bias and into the threaded portion 156 as depicted in the lower illustration of FIG. 6. This represents an unlocked position of the spring loaded lock pin 140. The access portion 158 may be rotated to temporarily lock the spring loaded lock pin 140 in its unlocked position. In the unlocked position, the first and second members 114, 116 may be rotatably and hingeably moved to their open position as depicted in FIG. 4. Rotation of the access portion 158 from the unlocked position allows slidable portion 154 to automatically extend under bias. This embodiment allows a user to retract the access portion 158 to withdraw the slidable portion 154 and rotate access portion 158 to secure slidable portion 154 in the withdrawn position with one hand. When slidable portion 154 is withdrawn first and second members 114, 116 will automatically open under their spring bias. After containers are inserted the user, with only one hand, can rotatably close first and second members 114, 116 against their spring bias and rotate access portion 158 to automatically extend slidable portion 154, securing first and second members 114, 116 in the closed position. The present disclosure, however, is not limited to the use of the spring loaded lock pin 140, and other suitable locking mechanisms may suitably be used. The access portion 158 may be disposed against the upper portion 117 of the front plate 108 to provide a detent 115 location for keeping the spring loaded lock pin in its locked position.

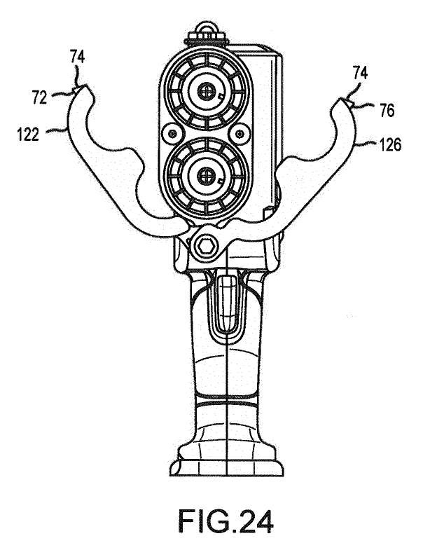

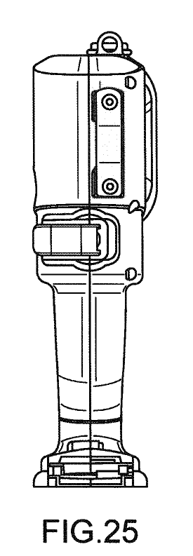

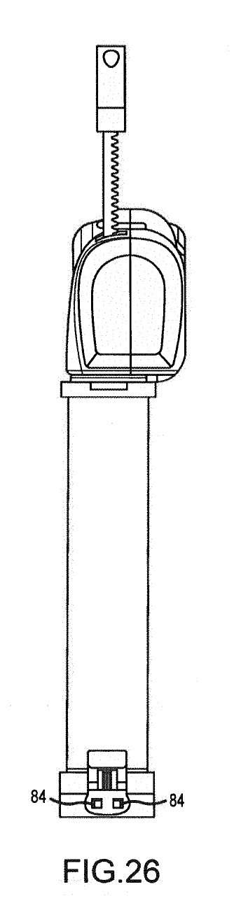

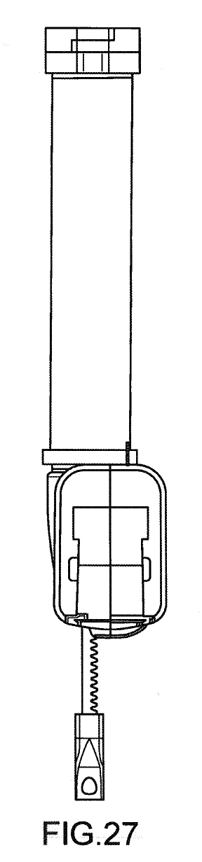

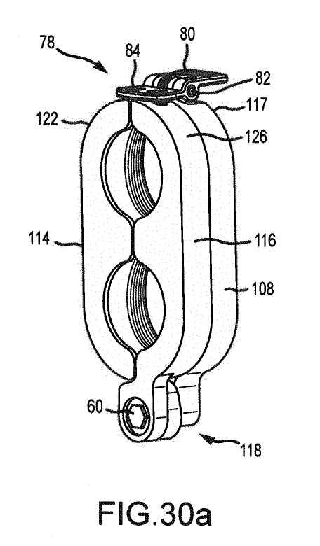

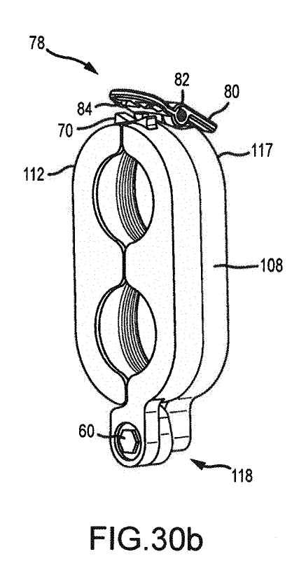

FIGS. 30a and 30b illustrate another embodiment of a release assembly. As shown best in FIG. 24 movable member upper portion 122 has a generally triangular lug 70 including an angled surface 71 and a shoulder 72. Movable member upper portion 126 has a generally triangular lug 74 including an angled surface 75 and a shoulder 76. With reference again to FIGS. 30a and 30b, the front plate upper portion 117 includes a lug (not shown) on which a lock mechanism 78 is movably mounted. The lock mechanism includes a release 80 mounted to the lug by a pin 82 so that the release can be rotated by a user around the pin from a locked position (shown in FIG. 30a) adjacent the movable member upper portions 122, 126 to a released position (shown in FIG. 30b) away from the upper portions 122, 126. The lock mechanism preferably includes a bias element such as a spring to resiliently bias the release 80 toward the locked position. The release comprises apertures interengagable with lugs 70, 74. A user can depress the rear portion of the release toward the tube 102 to raise the release apertures 84 away from lugs 70, 74. This allows the movable members 114, 116 to move to the open position shown in FIG. 24. In the open position a user can remove or insert containers 14 or 30 into the tubes 102, 104. When the user releases the rear portion the release is biased toward the locked position. A user can move the movable members 114, 116 to the closed position. As the lugs 70, 74 approach the release 80 the angled surfaces 71, 75 cam the release 80 against the bias, allowing the lugs 70, 74 to move within the release aperture. When the lugs 70, 74 are within the release aperture the release 80 is biased toward the closed position wherein the lug shoulders 72, 76 abut the release aperture to maintain the movable members 114, 116 in the closed position. This embodiment allows a user to open and close the movable members 114, 116 with only one hand. Further, this design allows a user to readily and ergonomically actuate release 80 with either the left or right hand.

FIG. 7 depicts a hinge bolt 160 useful as the hinge mechanism 118. The hinge bolt 160 contains a smooth portion 164 about which the first and second members 114, 116 are rotatably disposed. The threaded portion may be threadingly secured to a threaded hole 151 in the lower portion 153 of the front plate 108.

FIG. 8 depicts the bolts 142, 144 for securing the tie rods 110 to the front plate 108. The bolts 142, 144 may contain a lock ring 165 to further aid in the securement.

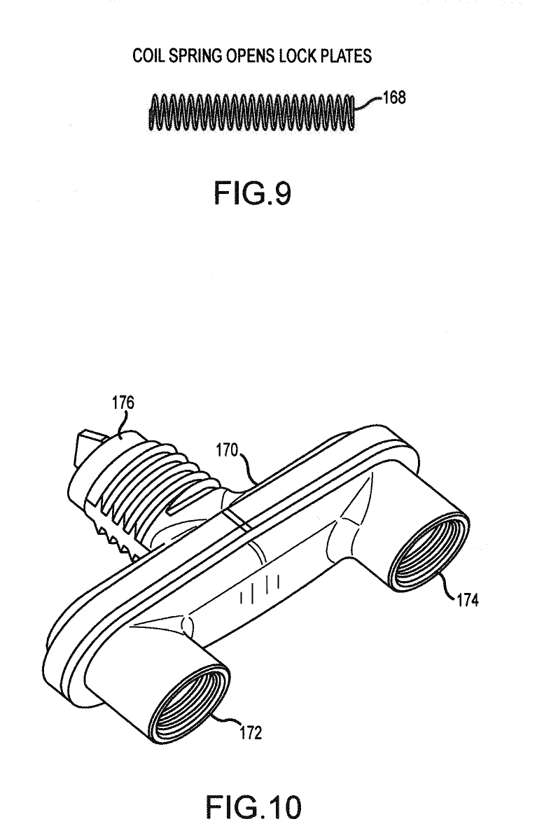

FIG. 9 depicts a coil spring 168. Coil spring is disposed between the lower portions 120, 124 of the respective first and second members 114, 116. The coil spring 168 biases the first and second members 114, 116 to the open position depicted in FIG. 4 when the slidable portion 154 is retracted from its biased position of engagement with the first and second members 114, 116. Other means for biasing the first and second members 114, 116 may suitably be used.

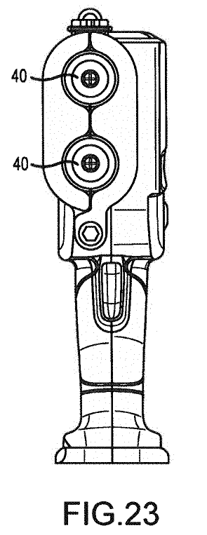

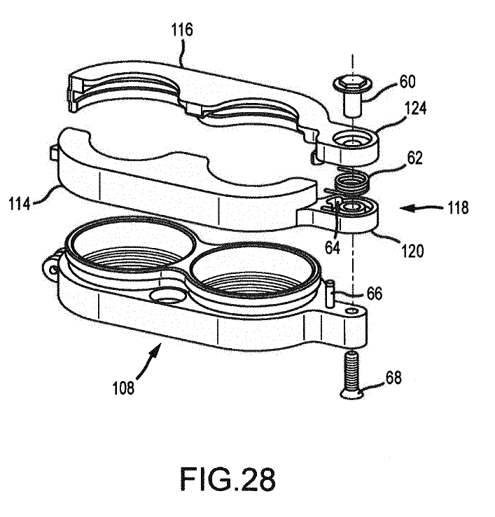

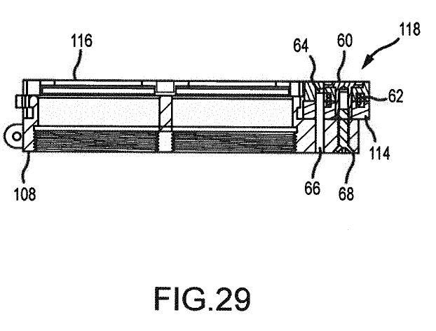

FIG. 28 depicts another embodiment of the front plate 108 and movable members 114, 116. In this embodiment the movable members 114, 116 comprise lower portions, 120, 124 respectively, which form a hinge 118. The lower portions 120, 124 include apertures. A bushing 60 can be disposed through the apertures and secured, for example by a screw 68, to the front plate 108 to allow the movable members 114, 116 to move from a closed position as shown in FIG. 23 in which the movable members are adjacent to an open position as shown in FIG. 24 in which the movable members are displaced. A bias member such as a torsion spring 62 resiliently biases the movable members to the open position. Advantageously, the torsion spring 62 is captured within recesses in the lower portions 120, 124. One or both of the lower portions 120, 124 can include a groove 64. A pin 66 secured to and projecting from the front plate 108 can be disposed within the grooves 64 to limit the degree of rotation of the movable members 116, 118 about the hinge 118. In the variation shown in FIG. 28 the groove 64 penetrates through the full width of lower portion 124 but only partially through the width of lower portion 120. This allows the pin to be retained between the blind groove 64 in lower portion 120 and front plate 108. FIG. 29 is a cross section of the hinge 118 of this embodiment.

FIG. 10 depicts a mixing manifold 170 useful with the assembly 10. The mixing manifold 170 may have two open portions 172, 174 and a discharge portion 176. The open portions 172, 174 may be threaded to outlets of cartridges or sausages to fluidly connect the cartridge or sausage to the mixing manifold. The discharge portion 176 can be fluidly connected to a mixing nozzle or a dispensing nozzle. In embodiments using two, reactive flowable compositions, a portion of each composition is forced into the mixing manifold 170 by actuation of the dispenser 12 and further forced into a mixing nozzle connected to discharge portion 176 to mix the two components. Mixing nozzles comprising internal static mixing elements are known. The mixed, flowable composition is dispensed from the tip of the mixing nozzle. In embodiments using two containers of the same flowable material, a portion of each composition is forced into the mixing manifold 170 by actuation of the dispenser 12 and further forced into a known dispensing nozzle connected to discharge portion 176 to dispense the flowable material. In this embodiment the assembly allows dispensing of twice the amount of flowable material compared to a gun using a single container.

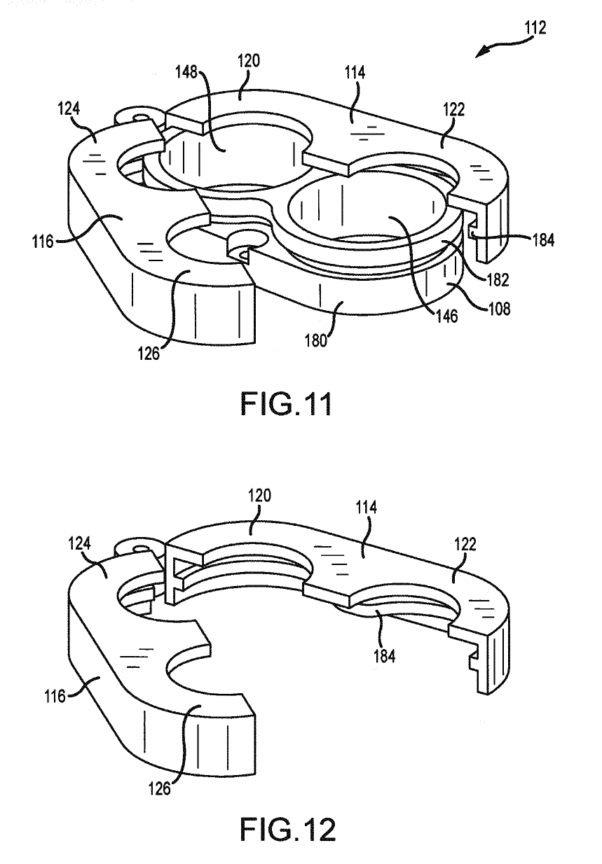

FIG. 11 is a partial perspective view of another embodiment of the release assembly 112 of FIG. 1. The front plate 108 may contain a base 180 and recessed raised portions 182 defining front plate orifices 148, 146. As depicted in FIG. 12, the first and second members 114, 116 may contain a ridge 184. The ridge 184 is slidable over the base 180 of the front member 108 and may engage the recessed raised portions 182 of the front plate 108. The first and second members 114, 116 may also be referred to as brezels or brezel portions as in their closed position they form a brezel-like structure.

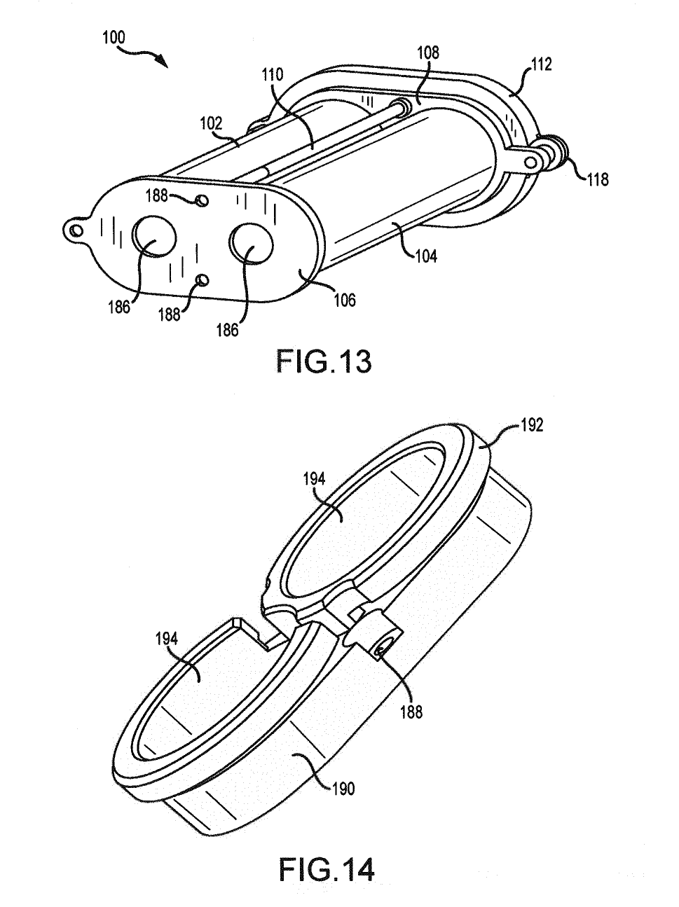

FIG. 13 is a rear perspective view of the assembly 100. The rear plate has orifices 186 which permit plungers or pistons (each 40, best shown in FIG. 23) from the dispenser 12 ingress and egress to the assembly 100. Holes 188 may also be provided in the rear plate 106. The tie rods 110 may be threaded through the holes 188 to secure the rear plate 106 to the front plate 108. The tie rods 110 may also be used to secure the assembly 100 to the dispenser 12 (not shown). Other means for securing the assembly 100 to the dispenser 12 may suitably be used, including releasably securing mechanisms.

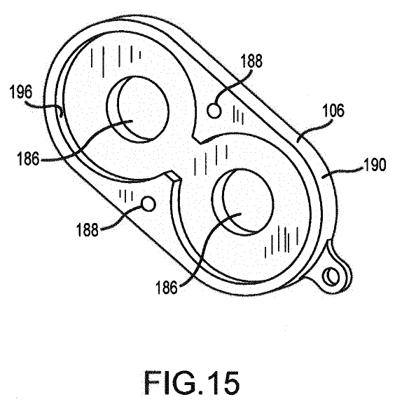

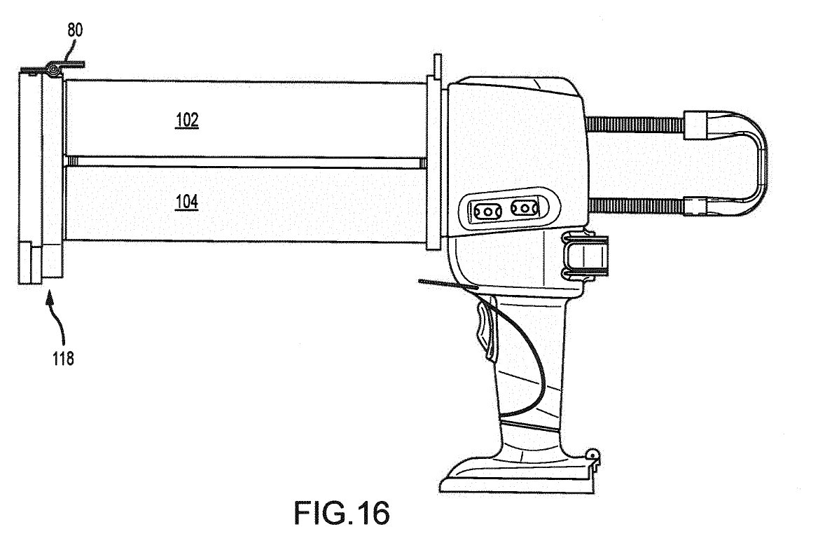

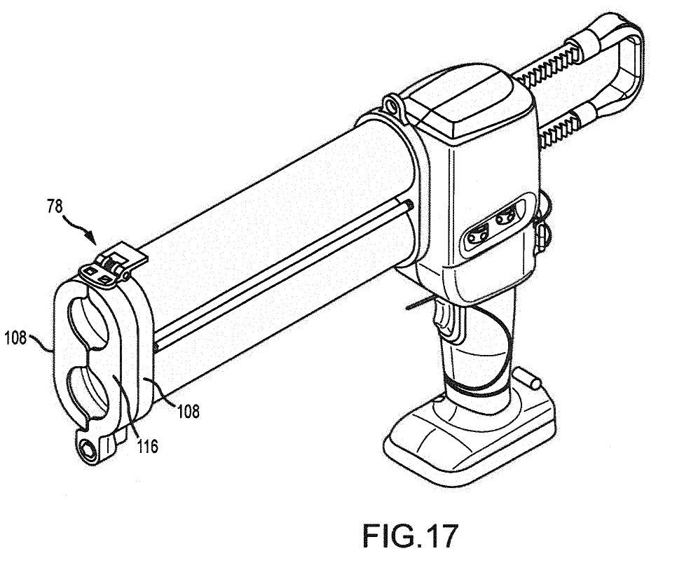

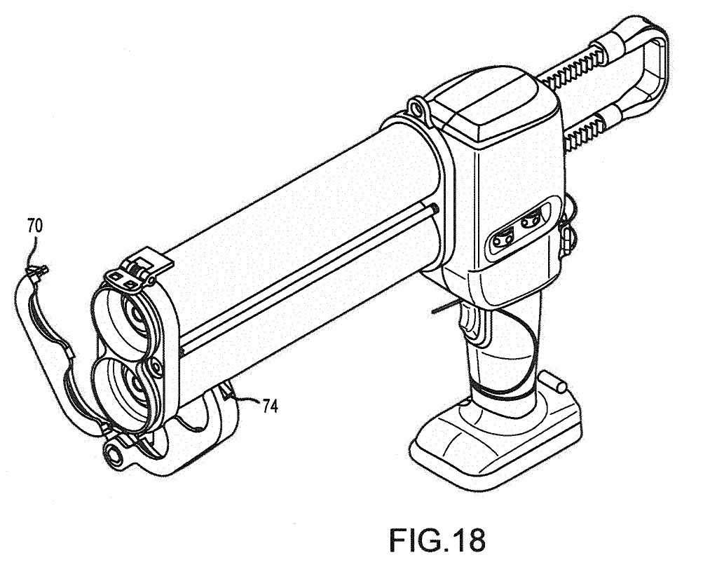

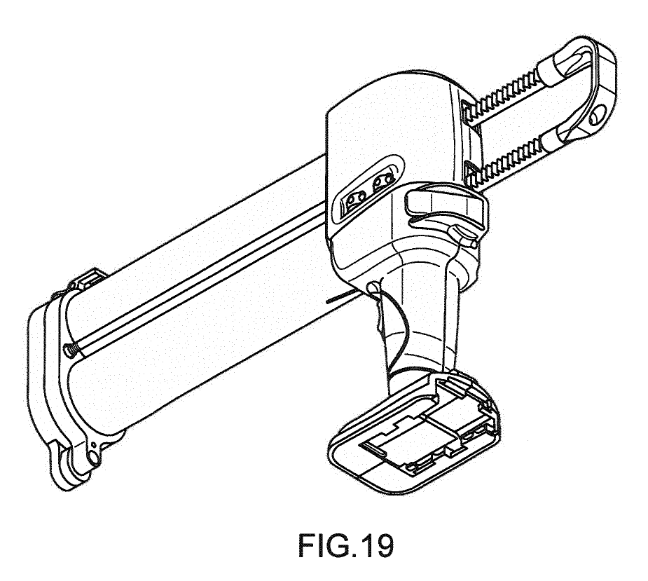

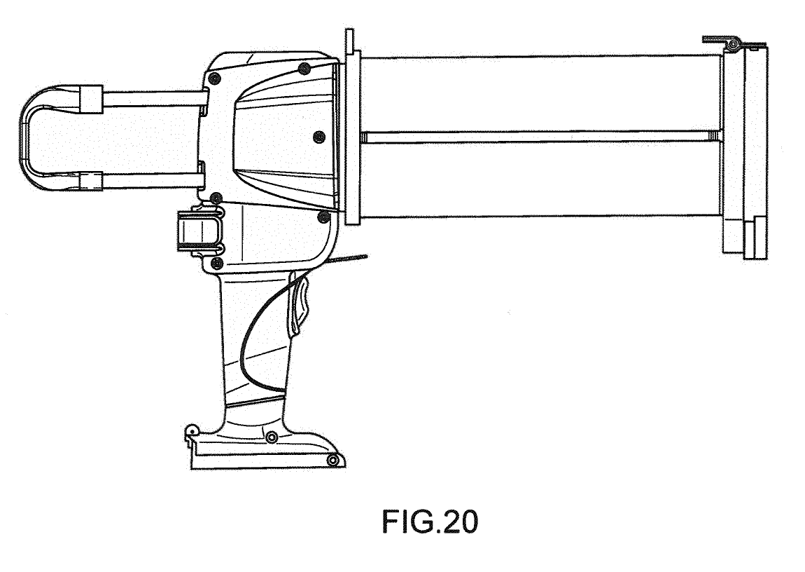

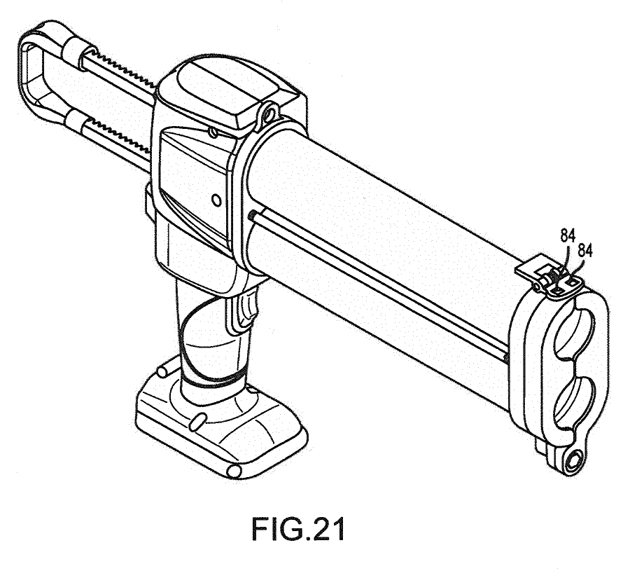

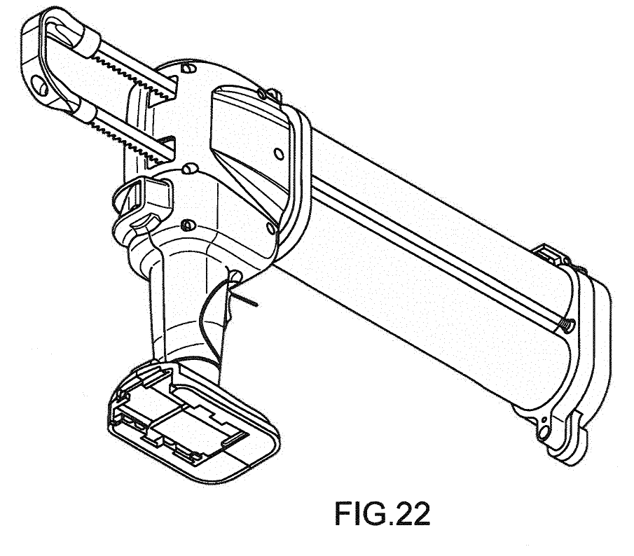

FIG. 15 is a partial perspective view of the rear plate 106 of the assembly 100. The rear plate 106 may include a base portion 190 and a raised portion 192 surrounding at least a portion of the base portion 190. The raised portion forms recesses. In one embodiment the tubes 102, 104 may be removably disposed within the recesses and secured thereto by the tie rods 110. This embodiment is advantageous as it allows a user to remove the tie rods 110 and quickly remove the tubes 102, 104 and front plate 108 as a unitary assembly. This allows ready access to the interior of tubes 102, 104 for cleaning, repair, etc. The tubes 102, 104 may also be securably disposed with the recesses by welding, adhesive bonding, press fitting and the like. The base portion defines apertures 186 axially aligned with the respective tube longitudinal axis. In one embodiment a bushing (not shown) defining an axial throughbore, a flange at one end and threads at the opposing end is inserted through each aperture. The flange fits within the recess and abuts the base portion. The threads project through the rear plate 106 and thread into the dispensing gun 12 to secure the rear plate 106 to the dispenser. Drive rods from the dispenser are disposed through the bushing throughbore.

FIG. 14 is a partial perspective view of another embodiment of the rear plate 106 of the assembly 100. As depicted in FIG. 14, the rear plate 106 may include a base portion 190 and a raised portion 192. The raised portions 192 have open orifices 194 whose geometry, such as diameter, substantially match the geometry of the tubes 102, 104. The tubes 102, 104 may be slidingly disposed within the orifices 194. The present disclosure, however, is not so limited. The tubes 102, 104 securably disposed with the orifices 194 by welding, adhesive bonding or sealing, press fitting and the like. The rear plate orifices 186 may be smaller than the orifices 194 of the raised portions 192 of the rear plate 106.

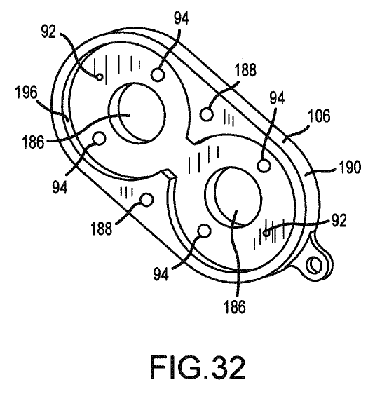

FIG. 32 is a perspective view of another embodiment of the rear plate 106. This embodiment includes pin apertures 92 and screw apertures 94. The dispenser includes projecting pins (not shown) which are disposed in the pin apertures 92 when the rear plate 106 is adjacent the dispenser. Interengagement of the pins within the pin apertures 92 helps to precisely align and position the rear plate 106 with respect the dispenser. Screws are disposed through the rear plate screw apertures 94 and interengaged with the dispenser to releasably secure the rear plate 106 to the dispenser.

The various components of the assembly 100 may be metallic components, plastic components and/or combinations of metallic and plastic materials.

While various embodiments of the present disclosure are specifically illustrated and/or described herein, it will be appreciated that modifications and variations may be effected by those skilled in the art without departing from the spirit and intended scope of the invention. Further, any of the embodiments or aspects of the disclosure as described in the claims or in the specification may be used with one and another without limitation.

1. An assembly for a dispenser comprising:
a front plate comprising a first tube aperture configured for securably receiving a tube within the aperture, the tube being configured to receive a container having a flowable material; and
a release assembly disposed on the front plate comprising first and second members hingingly movable about a hinge portion on each of the first and second members for partially covering the first tube aperture when the first and second members are in a closed position and for uncovering the first tube aperture when the first and second members are in an open position.

2. The assembly of claim 1, further comprising:
a hinge pin secured to the front plate;
wherein the hinge portion comprises a hinge aperture in each of the first and second members; and
wherein the hinge pin is disposed in the hinge aperture of each of the first and second members.

3. The assembly of claim 1, further comprising a spring for urging the first and second members to move from the closed position to the open position.

4. The assembly of claim 1, wherein the front plate further comprises a second tube aperture for securably receiving a second tube within the second tube aperture, the second tube being configured to receive a container having a flowable material; and
wherein the two members partially cover the first and second tube apertures when the first and second members are in a closed position and uncover the first and second tube apertures when the first and second members are in an open position.

5. The assembly of claim 1, wherein the tube is configured to receive more than one container having flowable materials therein, and wherein the first tube aperture is configured to receive the flowable materials from the containers.

6. The assembly of claim 1, further comprising a locking mechanism for releasably securing the first and second members to one and another in the closed position.

7. The assembly of claim 6, further comprising:
a locking aperture disposed through each of the first and second members;
wherein the locking mechanism further comprises a spring loaded lock pin slidably disposed within the locking apertures of the first and second members.

8. The assembly of claim 7, further comprising:
a detent disposed on the front plate for releasably securing the spring loaded lock pin.

9. The assembly of claim 6, wherein the locking mechanism comprises:
a release mounted to the front plate for selective rotation between a locked position and a released position, and
a bias element to resiliently bias the release toward the locked position;
wherein the first and second members each further comprise a locking element to interengage with the release in the locked position and maintain the first and second elements in the closed position.

10. The assembly of claim 6, wherein the locking mechanism comprises:
a release mounted to the front plate for selective rotation between a locked position and a released position, the release defining an aperture therein and
a bias element to resiliently bias the release toward the locked position;
wherein the first member comprises a lug projecting from an upper portion thereof, the second member comprises a lug projecting from an upper portion thereof, and the first and second member lugs are disposed within the release aperture when the release is in the locked position.

11. The assembly of claim 1, further comprising:
a rear plate; and
at least one rod for securing the rear plate to the front plate.

12. The assembly of claim 11, wherein the rear plate comprises a recess or orifice configured to receive a rear portion of the tube.

13. A combination comprising:
a dispenser; and
an assembly that during use is capable of being releasably secured to a discharge gun;
wherein the assembly comprises:
a front plate comprising a first tube aperture configured for securably receiving a front end of a tube within the aperture, the tube being configured to receive a container having a flowable material;
at least one rod for securing the rear plate to the front plate;
a release assembly disposed on the front plate comprising first and second members hingingly movable about a hinge portion on each of the first and second members for partially covering the first tube aperture when the first and second members are in a closed position and for uncovering the aperture when the first and second members are in an open position; and
a locking mechanism for releasably securing the first and second members to one and another in the closed position.

14. The combination of claim 13, wherein the rear plate comprises an aperture and a drive rod from the dispenser is disposed through the aperture.

15. Combination of claim 13, wherein the front plate further comprises a second tube aperture for securably receiving a second tube within the second tube aperture, the second tube being configured to receive a container having a flowable material;
wherein the two members partially cover the first and second tube apertures when the first and second members are in a closed position and uncover the first and second tube apertures when the first and second members are in an open position; and
wherein the rear plate comprises a second recess or orifice configured to receive a rear portion of the second tube.

16. The combination of claim 13, further comprising:
a hinge pin secured to the front plate;
wherein the hinge portion comprises a hinge aperture in each of the first and second members; and
wherein the hinge pin is disposed the in hinge aperture of each of the first and second members.

17. The combination of claim 13, further comprising:
a locking aperture disposed through each of the first and second members;
wherein the locking mechanism further comprises a spring loaded lock pin slidably disposed within the locking apertures of the first and second members.

18. The combination of claim 17, further comprising:
a detent disposed on the front plate for releasably securing the spring loaded lock pin.

19. A kit comprising:
a container having a flowable material;
a dispenser having a plunger; and
an assembly that during use is capable of being releasably secured to a discharge gun;
wherein the assembly comprises:
a front plate comprising a first tube aperture configured for securably receiving a front end of a tube within the aperture, the tube being configured to receive the container having the flowable material;
a rear plate comprising a recess or orifice configured to receive a rear portion of the tube;
at least one rod for securing the rear plate to the front plate;
a release assembly disposed on the front plate comprising first and second members hingingly movable about a hinge portion on each of the first and second members for partially covering the first tube aperture when the first and second members are in a closed position and for uncovering the aperture when the first and second members are in an open position; and
a locking mechanism for releasably securing the first and second members to one and another in the closed position;
wherein the rear plate comprises an aperture to receive the plunger from the dispenser for dispensing the flowable material from the front end of the tube.

20. The assembly for the dispenser of claim 4 further comprising a mixing manifold for having first and second passages removably coupled and in respective fluid communication with first and second tube apertures, said first and second passages combine in fluid communication at a single discharge passage.

21. An assembly for a dispenser comprising:
a front plate comprising a first tube aperture configured for securably receiving a tube within the aperture, the tube being configured to receive a container having a flowable material; and
a release assembly disposed on the front plate comprising first and second members hingingly movable about a hinge portion on each of the first and second members for partially covering the first tube aperture when the first and second members are in a closed position and for uncovering the first tube aperture when the first and second members are in an open position, both said first and second members having first and second sides, at least one of said first and second sides comprising a chamfered opening to facilitate concentric alignment between said first tube aperture and a secured opening formed by said first and second members when in said closed position.
